(19) United States
(12) Patent Application Publication
(10) Pub. No.: US 2026/0184059 A1
(43) Pub. Date: Jul. 2, 2026

(54) PEELING A PROTECTIVE FILM FROM A COMPOSITE MATERIAL SHEET

(71) Applicant: The Boeing Company, Arlington, VA (US)

(72) Inventors: Erik Nicholas Wienhold, Seattle, WA (US); Brian James Smith, Seattle, WA (US); Sandra Louise Zmeu, Shoreline, WA (US); Christopher Robert Brown, Seattle, WA (US); Ricardo Andreas Fritzke, Sammamish, WA (US); Sangvavann Heng, Buena Park, CA (US); Brice Aaron Johnson, Toledo, WA (US); Lisa C. Zgherea, Tukwila, WA (US)

(21) Appl. No.: 19/005,314

(22) Filed: Dec. 30, 2024

(51) Int. Cl. B32B 43/00; B25J 11/00

(52) U.S. Cl. CPC B32B 43/006; B25J 11/005; B32B 2605/18

(57) ABSTRACT

Methods of peeling a protective film from the composite material are presented. A second protective film on a second face of the composite material sheet is held against a plurality of gripping points of an end effector. The composite material sheet is positioned at an angle relative to the manufacturing floor using the end effector. A first protective film on a first face of the composite material sheet is gripped by a film removal end effector. The first protective film is peeled away from the first face of the composite material sheet by movement of the film removal end effector.

### STATEMENT OF GOVERNMENT INTEREST

This invention was made with Government support under contract number AFRL ManTech FA2394-23-C-B006 awarded by Department of Defense. The government has certain rights in this invention.

### BACKGROUND INFORMATION

### 1. Field

The present disclosure relates generally to composite manufacturing and more specifically to automated composite manufacturing.

### 2. Background

Automated material handling of ceramic matrix composite (CMC) fabric based material is made possible by having a top and bottom protective film on the material. Before laying up the ceramic matrix composite (CMC) fabric, the bottom protective film is removed. In an automated process, the removal of the bottom protective film would desirably be part of the automated process. However, controlled automated removal of the films has been undesirably difficult. In prior attempts at automated film removal, the top protective film has begun peeling while the bottom protective film is being removed. However, it is desirable to maintain the top protective film until the ceramic matrix composite (CMC) material has been placed and compacted on a layup tool or forming tool.

Therefore, it would be desirable to have a method and apparatus that takes into account at least some of the issues discussed above, as well as other possible issues.

### SUMMARY

An embodiment of the present disclosure provides a method of peeling a protective film from a composite material sheet. A second protective film on a second face of the composite material sheet is held against a plurality of gripping points of an end effector. The composite material sheet is positioned at an angle relative to the manufacturing floor using the end effector. A first protective film on a first face of the composite material sheet is gripped by a film removal end effector. The first protective film is peeled away from the first face of the composite material sheet by movement of the film removal end effector.

An embodiment of the present disclosure provides a method of peeling a protective film from a composite material sheet. The composite material sheet is positioned at an angle relative to a manufacturing floor using an end effector. A first protective film on a first face of the composite material sheet is gripped by a film removal end effector. The first protective film is peeled away from the first face of the composite material sheet by movement of the film removal end effector.

Yet another embodiment of the present disclosure provides a protective film peeling assembly. The protective film peeling assembly comprises an end effector with a head having a plurality of gripping points, and a film removal end effector with a suction cup directed towards the head of the end effector. The end effector is configured to position the head at an angle relative to a manufacturing floor.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of removing a protective film from a composite material in accordance with an illustrative embodiment;

FIG. 4 is an illustration of end effectors for removing a protective film from a composite material in accordance with an illustrative embodiment;

FIG. 5 is a flowchart of a method of peeling a protective film from a composite material sheet in accordance with an illustrative embodiment;

FIG. 6 is a flowchart of a method of peeling a protective film from a composite material sheet in accordance with an illustrative embodiment;

FIG. 7 is a flowchart of a method of peeling a protective film from a composite material sheet in accordance with an illustrative embodiment;

FIG. 8 is an illustration of an aircraft manufacturing and service method in a form of a block diagram in accordance with an illustrative embodiment; and

FIG. 9 is an illustration of an aircraft in a form of a block diagram in which an illustrative embodiment may be implemented.

### DETAILED DESCRIPTION

The illustrative examples recognize and take into account several considerations. The illustrative examples recognize and take into account that positioning of the material is important to successfully perform a bottom film peel. The illustrative examples recognize and take into account that the lower film is being peeled in a vertical orientation, the composite ply tends to come off of the upper film. The illustrative examples recognize and take into account that the ply is being held on both films by surface tension so the ply will often stay attached to the lower film, causing an undesirable or incomplete peel.

The illustrative examples present a dual robot armed system allows the optimum positioning of the material so that gravity can assist the film peel. The illustrative examples present an automated film peeling system. In the illustrative examples, gravity has a greater impact than surface tension in causing the material to stay adhered to the stationary backing film.

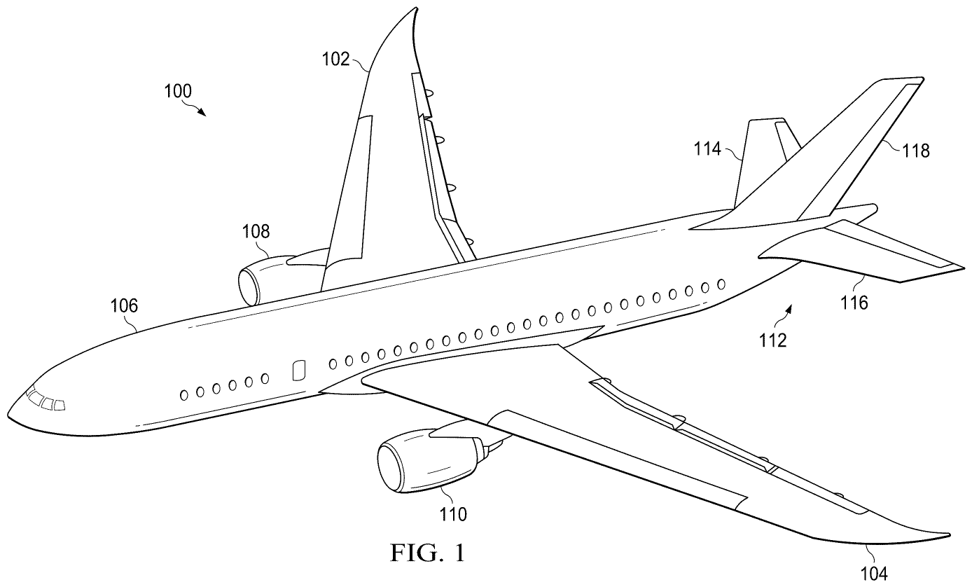

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite parts formed using the illustrative examples. A portion of wing 102, wing 104, or body 106 can be formed of a composite material laid up following an automated peel of the protective film.

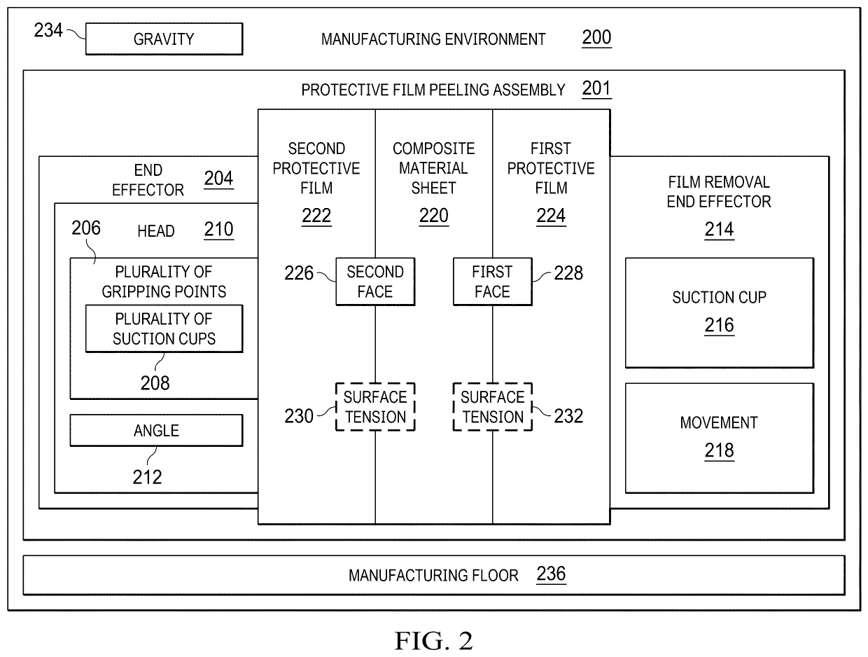

Turning now to FIG. 2, an illustration of a block diagram of a manufacturing environment is depicted in accordance with an illustrative embodiment. Manufacturing environment 200 can be an environment in which composite material for a composite part of aircraft 100 is picked and placed.

Protective film peeling assembly 201 is configured to peel a protective film from composite material sheet 220. Protective films, first protective film 224 and second protective film 222, are used for handling composite material sheet 220. Prior to placing first face 228 against a mandrel or a forming tool, first protective film 224 is removed. In some illustrative examples, first protective film 224 can be considered a “back film”.

Protective film peeling assembly 201 comprises end effector 204 with head 210 having plurality of gripping points 206 and film removal end effector 214 with suction cup 216 directed towards head 210 of end effector 204. End effector 204 is configured to position head 210 at angle 212 relative to manufacturing floor 236.

In some illustrative examples, plurality of gripping points 206 comprise plurality of suction cups 208. Vacuum through plurality of suction cups 208 can be used to grip second protective film 222.

End effector 204 holds composite material sheet 220 during peeling of first protective film 224 away from composite material sheet 220. End effector 204 holds second protective film 222 that is on second face 226 of composite material sheet 220 against plurality of gripping points 206 of end effector 204. Composite material sheet 220 is positioned at angle 212 relative to manufacturing floor 236 using end effector 204. Film removal end effector 214 grips first protective film 224 on first face 228 of composite material sheet 220. Movement 218 of film removal end effector 214 peels first protective film 224 away from first face 228 of composite material sheet 220.

In some illustrative examples, holding composite material sheet 220 against plurality of gripping points 206 comprises holding second protective film 222 on second face 226 of composite material sheet 220 with plurality of suction cups 208 of end effector 204. In some illustrative examples, holding composite material sheet 220 against plurality of gripping points 206 comprises applying vacuum through plurality of suction cups 208 of end effector 204.

Prior to peeling first protective film 224 from composite material sheet 220, first protective film 224 is maintained against first face 228 of composite material sheet 220 by surface tension 232. Second protective film 222 is maintained against second face 226 of composite material sheet 220 by surface tension 230. By holding composite material sheet 220 at angle 212, gravity 234 aids surface tension 232 in maintaining second protective film 222 against second face 226 of composite material sheet 220. Composite material sheet 220 is positioned at angle 212 configured to provide gravity 234 assist to surface tension 230 to maintain second protective film 222 on second face 226. In some illustrative examples, angle 212 relative to manufacturing floor 236 is in the range of 0 degrees to 60 degrees. In some illustrative examples, angle 212 relative to manufacturing floor 236 is in the range of 15 degrees to 60 degrees. In some illustrative examples, angle 212 relative to manufacturing floor 236 is in the range of 30 degrees to 60 degrees. In some illustrative examples, angle 212 relative to manufacturing floor 236 is in the range of 15 degrees to 45 degrees.

In some illustrative examples, peeling first protective film 224 away from first face 228 of composite material sheet 220 by movement of film removal end effector 214 comprises moving film removal end effector 214 away from first face 228 of composite material sheet 220. In some illustrative examples, peeling first protective film 224 away from first face 228 of composite material sheet 220 comprises moving film removal end effector 214 at an angle away from manufacturing floor 236. In some illustrative examples, method 500 locally breaks surface tension between first protective film 224 and first face 228 prior to moving film removal end effector 214 away from first face 228 of the composite material sheet 220.

The peeling of protective films from composite material sheet 220 is automated in manufacturing environment 200. Automating of peeling of first protective film 224 allows for automated layup of composite materials.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

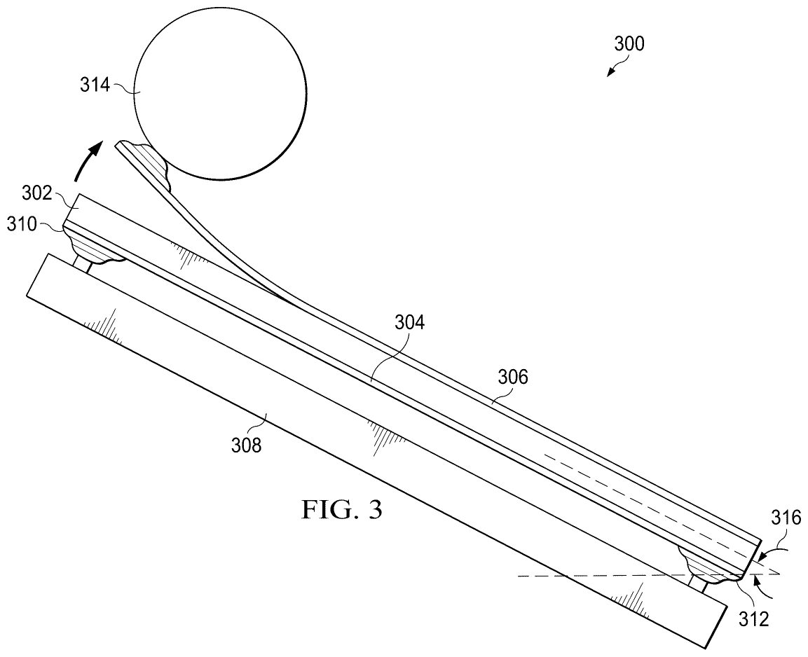

Turning now to FIG. 3, an illustration of removing a protective film from a composite material is depicted in accordance with an illustrative embodiment. Composite material sheet 302 with second protective film 304 and first protective film 306 can be a physical implementation of composite material sheet 220 of FIG. 2.

In view 300, composite material sheet 302 is held at angle 316 relative to the manufacturing floor. In view 300, composite material sheet 302 is neither horizontal nor vertical relative to the manufacturing floor.

End effector 308 comprises head having plurality of gripping points 312. End effector 308 is configured to position the head at an angle relative to a manufacturing floor. In this illustrative example, end effector 308 is holding composite material sheet 302 at angle 316 relative to the manufacturing floor. Film removal end effector 314 with suction cup is directed towards head of end effector 308. In this illustrative example, plurality of gripping points 312 comprises plurality of suction cups 310.

Film removal end effector 314 is depicted during peeling of first protective film 306 from composite material sheet 302. First protective film 306 on the first face of composite material sheet 302 is gripped by film removal end effector 314. Plurality of gripping points 312 of end effector 308 hold second protective film 304 that is on the second face of composite material sheet 302.

End effector 308 has positioned composite material sheet 302 at angle 316 relative to the manufacturing floor. In this illustrative example, positioning composite material sheet 302 at angle 316 comprises positioning composite material sheet 302 at angle 316 configured to provide gravity assist to surface tension maintaining the second protective film 304 on the second face.

In this illustrative example, film removal end effector 314 is peeling first protective film 306 away from the first face of composite material sheet 302 by movement of film removal end effector 314. In this illustrative example, peeling first protective film 306 away from the first face of composite material sheet 302 comprises moving film removal end effector 314 away from the first face of composite material sheet 302.

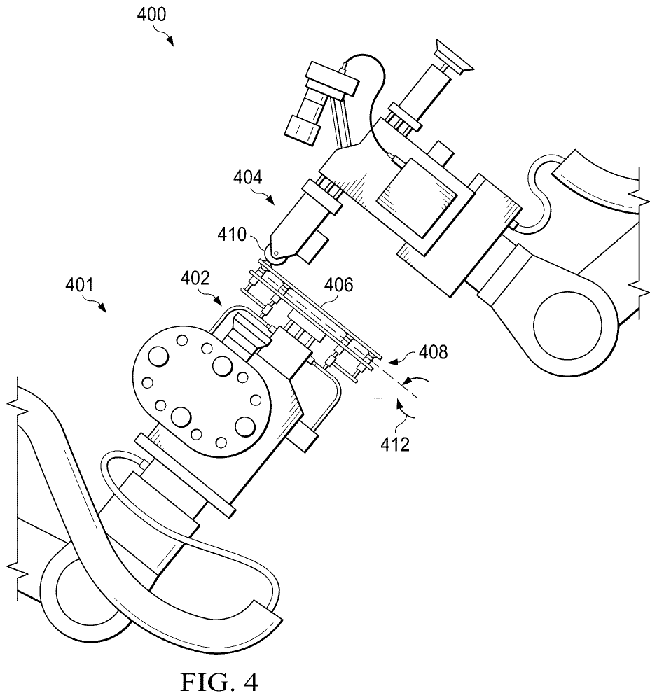

Turning now to FIG. 4, an illustration of end effectors for removing a protective film from a composite material is depicted in accordance with an illustrative embodiment. End effector 401 is a physical implementation of end effector 204. Film removal end effector 404 is a physical implementation of film removal end effector 214 of FIG. 2. End effector 401 can be the same as end effector 308 of FIG. 3. Film removal end effector 404 can be the same as film removal end effector 314 of FIG. 3.

End effector 401 comprises head 402 having plurality of gripping points 408. End effector 401 is configured to position the head at an angle relative to a manufacturing floor. In this illustrative example, end effector 401 is holding composite material sheet 406 at angle 412 relative to the manufacturing floor. Film removal end effector 404 with suction cup 410 is directed towards head 402 of end effector 401. In this illustrative example, plurality of gripping points 408 comprises a plurality of suction cups.

Film removal end effector 404 is depicted prior to beginning to peel a protective film from composite material sheet 406. The first protective film on the first face of composite material sheet 406 is gripped by film removal end effector 404. Plurality of gripping points 408 of end effector 401 hold the second protective film that is on the second face of composite material sheet 406.

End effector 401 has positioned composite material sheet 406 at angle 412 relative to the manufacturing floor. In this illustrative example, positioning composite material sheet 406 at angle 412 comprises positioning composite material sheet 406 at angle 412 configured to provide gravity assist to surface tension maintaining the second protective film on the second face.

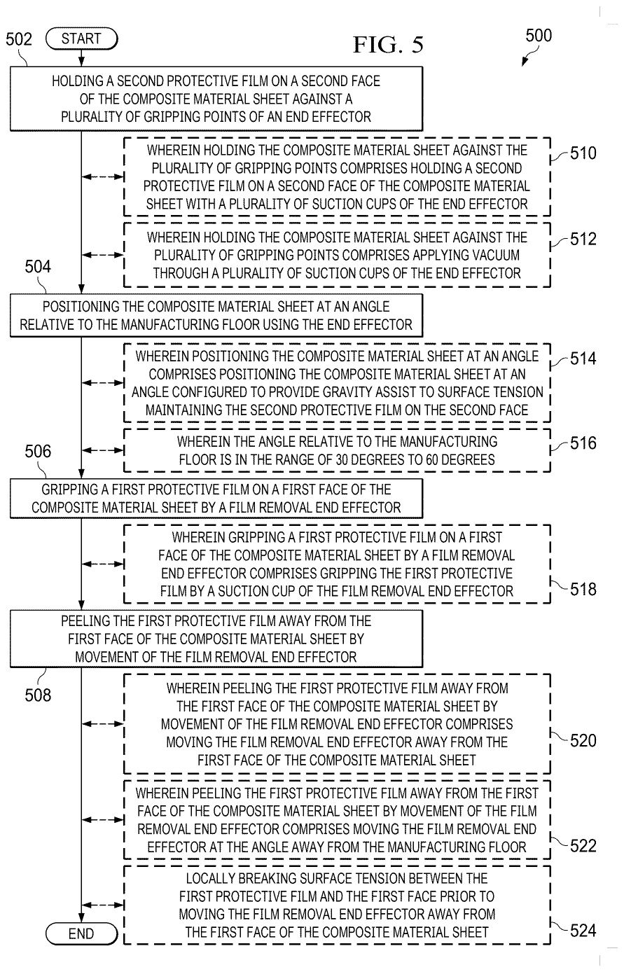

Turning now to FIG. 5 is a flowchart of a method of peeling a protective film from a composite material sheet is depicted in accordance with an illustrative embodiment. Method 500 can be used to form a composite part of aircraft 100 of FIG. 1. Method 500 can be performed on composite material sheet 220 of FIG. 2. Method 500 can be performed on composite material sheet 302 of FIG. 3. Method 500 can be performed on composite material sheet 406 of FIG. 4.

Method 500 holds a second protective film on a second face of the composite material sheet against a plurality of gripping points of an end effector (operation 502). Method 500 positions the composite material sheet at an angle relative to the manufacturing floor using the end effector (operation 504). Method 500 grips a first protective film on a first face of the composite material sheet by a film removal end effector (operation 506). Method 500 peels the first protective film away from the first face of the composite material sheet by movement of the film removal end effector (operation 508). Afterwards, method 500 terminates.

In some illustrative examples, holding the composite material sheet against the plurality of gripping points comprises holding a second protective film on a second face of the composite material sheet with a plurality of suction cups of the end effector (operation 510). In some illustrative examples, holding the composite material sheet against the plurality of gripping points comprises applying vacuum through a plurality of suction cups of the end effector (operation 512).

In some illustrative examples, positioning the composite material sheet at an angle comprises positioning the composite material sheet at an angle configured to provide gravity assist to surface tension maintaining the second protective film on the second face (operation 514). In some illustrative examples, the angle relative to the manufacturing floor is in the range of 30 degrees to 60 degrees (operation 516). In some illustrative examples, the angle relative to the manufacturing floor is in the range of 15 degrees to 60 degrees. In some illustrative examples, the angle relative to the manufacturing floor is in the range of 30 degrees to 60 degrees. In some illustrative examples, the angle relative to the manufacturing floor is in the range of 15 degrees to 45 degrees.

In some illustrative examples, gripping a first protective film on a first face of the composite material sheet by a film removal end effector comprises gripping the first protective film by a suction cup of the film removal end effector (operation 518).

In some illustrative examples, peeling the first protective film away from the first face of the composite material sheet by movement of the film removal end effector comprises moving the film removal end effector away from the first face of the composite material sheet (operation 520). In some illustrative examples, peeling the first protective film away from the first face of the composite material sheet by movement of the film removal end effector comprises moving the film removal end effector at the angle away from the manufacturing floor (operation 522). In some illustrative examples, method 500 locally breaks surface tension between the first protective film and the first face prior to moving the film removal end effector away from the first face of the composite material sheet (operation 524).

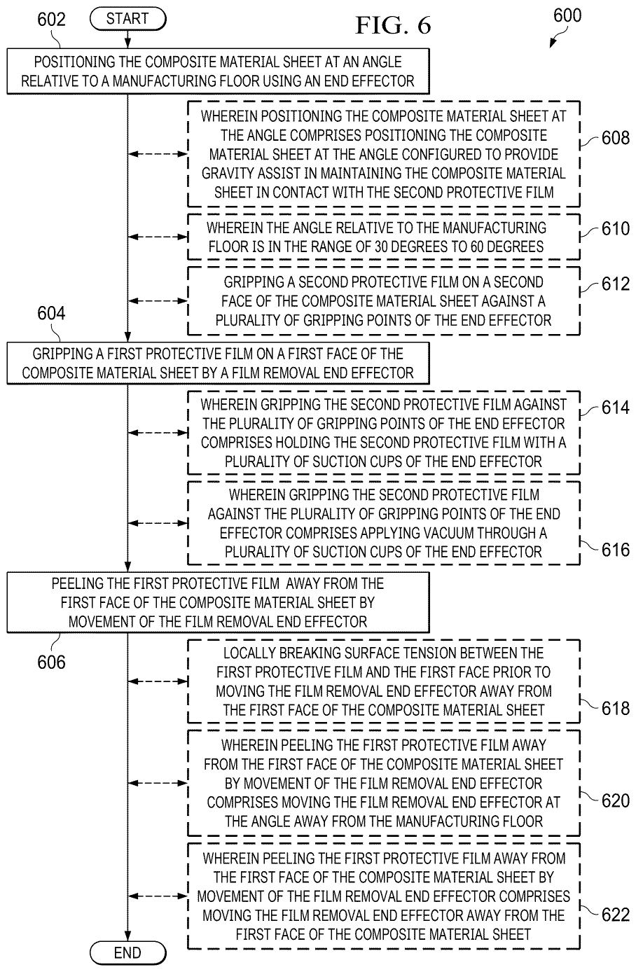

Turning now to FIG. 6, a flowchart of a method of peeling a protective film from a composite material sheet is depicted in accordance with an illustrative embodiment. Method 600 can be used to form a composite part of aircraft 100 of FIG. 1. Method 600 can be performed on composite material sheet 220 of FIG. 2. Method 600 can be performed on composite material sheet 302 of FIG. 3. Method 600 can be performed on composite material sheet 406 of FIG. 4.

Method 600 positions the composite material sheet at an angle relative to a manufacturing floor using an end effector (operation 602). Method 600 grips a first protective film on a first face of the composite material sheet by a film removal end effector (operation 604). Method 600 peels the first protective film away from the first face of the composite material sheet by movement of the film removal end effector (operation 606). Afterwards, method 600 terminates.

In some illustrative examples, positioning the composite material sheet at the angle comprises positioning the composite material sheet at the angle configured to provide gravity assist in maintaining the composite material sheet in contact with the second protective film (operation 608). In some illustrative examples, the angle relative to the manufacturing floor is in the range of 30 degrees to 60 degrees (operation 610). In some illustrative examples, the angle relative to the manufacturing floor is in the range of 15 degrees to 60 degrees. In some illustrative examples, the angle relative to the manufacturing floor is in the range of 30 degrees to 60 degrees. In some illustrative examples, the angle relative to the manufacturing floor is in the range of 15 degrees to 45 degrees.

In some illustrative examples, method 600 grips a second protective film on a second face of the composite material sheet against a plurality of gripping points of the end effector (operation 612). In some illustrative examples, gripping the second protective film against the plurality of gripping points of the end effector comprises holding the second protective film with a plurality of suction cups of the end effector (operation 614). In some illustrative examples, gripping the second protective film against the plurality of gripping points of the end effector comprises applying vacuum through a plurality of suction cups of the end effector (operation 616).

In some illustrative examples, method 600 locally breaks surface tension between the first protective film and the first face prior to moving the film removal end effector away from the first face of the composite material sheet (operation 618). In some illustrative examples, peeling the first protective film away from the first face of the composite material sheet by movement of the film removal end effector comprises moving the film removal end effector at the angle away from the manufacturing floor (operation 620). In some illustrative examples, peeling the first protective film away from the first face of the composite material sheet by movement of the film removal end effector comprises moving the film removal end effector away from the first face of the composite material sheet (operation 622).

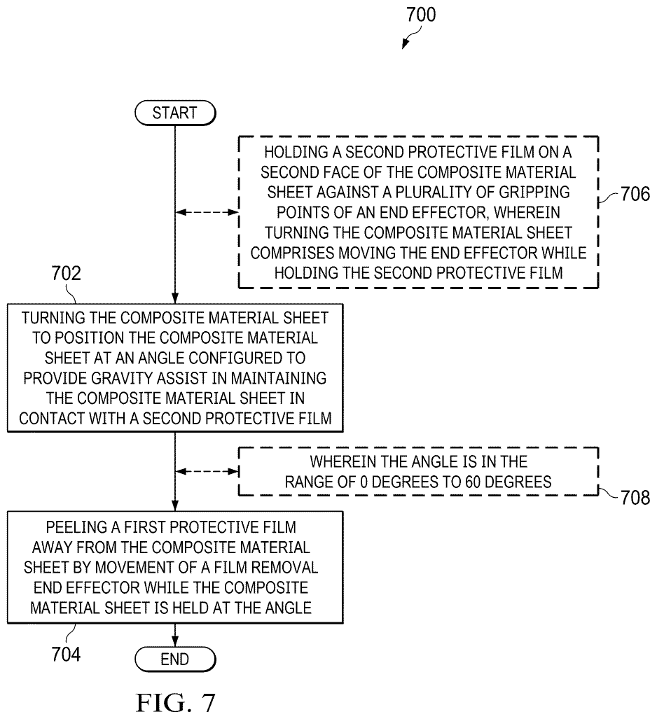

Turning now to FIG. 7, a flowchart of a method of peeling a protective film from a composite material sheet is depicted in accordance with an illustrative embodiment. Method 700 can be used to form a composite part of aircraft 100 of FIG. 1. Method 700 can be performed on composite material sheet 220 of FIG. 2. Method 700 can be performed on composite material sheet 302 of FIG. 3. Method 700 can be performed on composite material sheet 406 of FIG. 4.

The composite material sheet is turned to position the composite material sheet at an angle configured to provide gravity assist in maintaining the composite material sheet in contact with a second protective film (operation 702). A first protective film is peeled away from the composite material sheet by movement of a film removal end effector while the composite material sheet is held at the angle (operation 704). Afterwards, method 700 terminates.

In some illustrative examples, method 700 holds a second protective film on a second face of the composite material sheet against a plurality of gripping points of an end effector, wherein turning the composite material sheet comprises moving the end effector while holding the second protective film (operation 706).

In some illustrative examples, the angle is in the range of 0 degrees to 60 degrees (operation 708). In some illustrative examples, the angle is in the range of 15 degrees to 60 degrees. In some illustrative examples, the angle is in the range of 30 degrees to 60 degrees. In some illustrative examples, the angle is in the range of 15 degrees to 45 degrees.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, any of operation 510 through operation 524 may be optional. Additionally, any of operation 608 through operation 622 may be optional. Also, any of operation 706 through operation 708 may be optional.

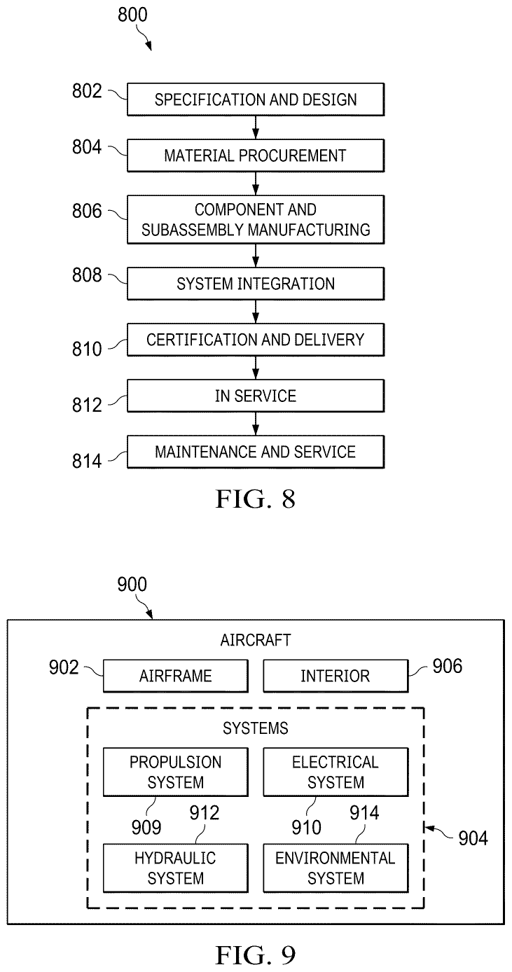

Illustrative embodiments of the present disclosure may be described in the context of aircraft manufacturing and service method 800 as shown in FIG. 8 and aircraft 900 as shown in FIG. 8. Turning first to FIG. 8, an illustration of an aircraft manufacturing and service method in a form of a block diagram is depicted in accordance with an illustrative embodiment. During pre-production, aircraft manufacturing and service method 800 may include specification and design 802 of aircraft 900 in FIG. 8 and material procurement 804.

During production, component and subassembly manufacturing 806 and system integration 808 of aircraft 900 takes place. Thereafter, aircraft 900 may go through certification and delivery 810 in order to be placed in service 812. While in service 812 by a customer, aircraft 900 is scheduled for routine maintenance and service 814, which may include modification, reconfiguration, refurbishment, or other maintenance and service.

Each of the processes of aircraft manufacturing and service method 800 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 9, an illustration of an aircraft in a form of a block diagram is depicted in which an illustrative embodiment may be implemented. In this example, aircraft 900 is produced by aircraft manufacturing and service method 800 of FIG. 8 and may include airframe 902 with plurality of systems 904 and interior 906. Examples of systems 904 include one or more of propulsion system 908, electrical system 910, hydraulic system 912, and environmental system 914. Any number of other systems may be included.

Apparatuses and methods embodied herein may be employed during at least one of the stages of aircraft manufacturing and service method 800. One or more illustrative embodiments may be manufactured or used during at least one of component and subassembly manufacturing 806, system integration 808, in service 812, or maintenance and service 814 of FIG. 8.

The illustrative examples provide a dual robot armed system that enable positioning of the material so that gravity can assist the film peel. In the illustrative examples, gravity plays a greater role in maintaining the protective film than the surface tension of the material. The gravity causes the composite material to stay adhered to stationary backing film.

The illustrative examples provide a gravity assisted peel. The backing film is removed from both sides of material. A suction cup grips a corner of film and rolls it up. A bottom film is peeled first. The CMC material is held upside down to use gravity to help peel the bottom film.

The illustrative examples utilize a peel end effector mounted to a robot. In the illustrative examples, the suction cup end effector can be oriented such that gravity will hold the ply onto the lower backing film during the peel. In some illustrative examples, there then can be a coordinated move between both robots to consistently peel the lower film without having an undesirable peel.

The illustrative examples position the layup tool so that gravity assists holding the CMC material in place. The illustrative examples retrieve position and orientation of an upper right corner of a ply on a tool based on ply geometry and ply sequence number. The film removal end effector is sent to a safe approach position above the tool. The suction cup is moved to a position for peeling the film, such as the upper right corner of ply geometry. A vacuum is turned on for a suction cup on the film removal end effector. In some illustrative examples, a vacuum sensor shows successful contact. The film removal end effector is moved to separate the protective film (ply backing) from the composite ply and simultaneously clamp ply backing.

After peeling the protective film from the composite ply, the vacuum is turned off for the suction cup on the film removal end effector. The film removal end effector drops the ply backing into a bin.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of peeling a protective film from a composite material sheet comprising:
holding a second protective film on a second face of the composite material sheet against a plurality of gripping points of an end effector;
positioning the composite material sheet at an angle relative to a manufacturing floor using the end effector;
gripping a first protective film on a first face of the composite material sheet by a film removal end effector; and
peeling the first protective film away from the first face of the composite material sheet by movement of the film removal end effector.

2. The method of claim 1, wherein holding the composite material sheet against the plurality of gripping points comprises holding a second protective film on a second face of the composite material sheet with a plurality of suction cups of the end effector.

3. The method of claim 1, wherein holding the composite material sheet against the plurality of gripping points comprises applying vacuum through a plurality of suction cups of the end effector.

4. The method of claim 1, wherein positioning the composite material sheet at an angle comprises positioning the composite material sheet at an angle configured to provide gravity assist to surface tension maintaining the second protective film on the second face.

5. The method of claim 1, wherein gripping a first protective film on a first face of the composite material sheet by a film removal end effector comprises gripping the first protective film by a suction cup of the film removal end effector.

6. The method of claim 1, wherein peeling the first protective film away from the first face of the composite material sheet by movement of the film removal end effector comprises moving the film removal end effector away from the first face of the composite material sheet.

7. The method of claim 1, further comprising:
locally breaking surface tension between the first protective film and the first face prior to moving the film removal end effector away from the first face of the composite material sheet.

8. The method of claim 1, wherein peeling the first protective film away from the first face of the composite material sheet by movement of the film removal end effector comprises moving the film removal end effector at the angle away from the manufacturing floor.

9. The method of claim 1, wherein the angle relative to the manufacturing floor is in the range of 0 degrees to 60 degrees.

10. A method of peeling a protective film from a composite material sheet comprising:
positioning the composite material sheet at an angle relative to a manufacturing floor using an end effector;
gripping a first protective film on a first face of the composite material sheet by a film removal end effector; and
peeling the first protective film away from the first face of the composite material sheet by movement of the film removal end effector.

11. The method of claim 10 further comprising:
gripping a second protective film on a second face of the composite material sheet against a plurality of gripping points of the end effector.

12. The method of claim 11, wherein positioning the composite material sheet at the angle comprises positioning the composite material sheet at the angle configured to provide gravity assist in maintaining the composite material sheet in contact with the second protective film.

13. The method of claim 11, wherein gripping the second protective film against the plurality of gripping points of the end effector comprises holding the second protective film with a plurality of suction cups of the end effector.

14. The method of claim 11, wherein gripping the second protective film against the plurality of gripping points of the end effector comprises applying vacuum through a plurality of suction cups of the end effector.

15. The method of claim 10, wherein peeling the first protective film away from the first face of the composite material sheet by movement of the film removal end effector comprises moving the film removal end effector away from the first face of the composite material sheet.

16. The method of claim 10 further comprising:
locally breaking surface tension between the first protective film and the first face prior to moving the film removal end effector away from the first face of the composite material sheet.

17. The method of claim 10, wherein peeling the first protective film away from the first face of the composite material sheet by movement of the film removal end effector comprises moving the film removal end effector at the angle away from the manufacturing floor.

18. The method of claim 10, wherein the angle relative to the manufacturing floor is in the range of 0 degrees to 60 degrees.

19. A protective film peeling assembly comprising:
an end effector with a head having a plurality of gripping points, the end effector configured to position the head at an angle relative to a manufacturing floor; and
a film removal end effector with a suction cup directed towards the head of the end effector.

20. The protective film peeling assembly of claim 19, wherein the plurality of gripping points comprise a plurality of suction cups.

21. A method of peeling a protective film from a composite material sheet comprising:
turning the composite material sheet to position the composite material sheet at an angle configured to provide gravity assist in maintaining the composite material sheet in contact with a second protective film; and
peeling a first protective film away from the composite material sheet by movement of a film removal end effector while the composite material sheet is held at the angle.

22. The method of claim 21, wherein the angle is in the range of 0 degrees to 60 degrees.

23. The method of claim 21 further comprising:
holding a second protective film on a second face of the composite material sheet against a plurality of gripping points of an end effector, wherein turning the composite material sheet comprises moving the end effector while holding the second protective film.
